(19) United States
(12) Patent Application Publication
(10) Pub. No.: US 2023/0411733 A1
(43) Pub. Date: Dec. 21, 2023

(54) BATTERY CELL

(71) Applicant: John Deere Electric Powertrain LLC, Moline, IL (US)

(72) Inventor: Philipp Kreisel, Freistadt (AT)

(21) Appl. No.: 18/035,053

(22) PCT Filed: Nov. 8, 2021
(86) PCT No.: PCT/AT2021/060416

§ 371 Date: May 2, 2023

(30) Foreign Application Priority Data
Nov. 26, 2020 (AT) A51032/2020

(51) Int. Cl. H01M 10/6568; H01M 50/107; H01M 50/184; H01M 50/186

(52) U.S. Cl. CPC H01M 10/6568; H01M 50/107; H01M 50/184; H01M 50/186

(57) ABSTRACT

A battery cell has electrodes (2) surrounded by a cell casing (1), with an end portion (3) of the cell casing (1) forming a circular cylinder. The battery cell in particular when used in a fluid-temperature-controlled battery module with good temperature-control properties, has reliably sealed storage and the energy density of circular-cylindrical battery cells is thus exceeded. A receiving portion (4) connects, at the circular-cylindrical end portion (3), to lateral surfaces that are parallel opposite one another in pairs.

### FIELD OF THE INVENTION

The invention relates to a battery cell having electrodes surrounded by a cell casing, wherein an end portion of the cell casing forms a circular cylinder.

### DESCRIPTION OF THE PRIOR ART

Battery cells are known from the prior art whose cell casings have various basic shapes. The shape of the cell casing influences several parameters of the battery cell, e.g. it determines the ratio of the battery cell surface to the battery cell volume and the way in which the electrodes and any other components are arranged within the battery cell. In battery cells with a circular-cylindrical main body, the anode, separator layer and cathode are usually arranged on top of each other and wound spirally into a so-called jelly roll in order to make efficient use of the available space in the main body. Circular-cylindrical battery cells have the advantage (AT522356A4) that their compact design not only allows flexible assembly of battery modules, but also that their circular cross-section within a battery module permits simple sealing of a flow channel for a temperature-control fluid. In addition, favorable flow conditions are created within the flow channel. The disadvantage, however, is that the spirally wound jelly roll leads to asymmetrical cell respiration under load, so that a relatively high level of design effort is required for overdetermination-free storage that also takes cell respiration into account. Furthermore, without additional measures, there is an uneven temperature distribution within a battery module because the temperature-control fluid adapts to the temperature of the individual battery cells as it flows through the flow channel.

### SUMMARY OF THE INVENTION

The invention is thus based on the object of demonstrating a battery cell which, in particular in an application in a fluid-temperature-controlled battery module, permits reliably sealed storage with good temperature-control properties and thereby exceeds the energy density of circular-cylindrical battery cells.

The invention solves the set object in that the circular-cylindrical end portion is adjoined by a receiving portion having lateral surfaces that are parallel opposite one another in pairs. The circular-cylindrical end portion permits a reliably sealed bearing because the electrochemically active electrodes can be concentrated in the receiving portion and thus a change in geometry at the end portion due to operation is avoided. The circular-cylindrical end portion also has the advantage of better sealing in the event of undesirable rotational movements caused by vibration. It follows that a circular-cylindrical end portion according to the invention is not understood to mean a contact pin led out of the battery cell at the end face, but rather a part of the battery cell casing whose circular diameter can be at least 50%, preferably at least 80%, of the diameter of the largest circle that can be inscribed in the cross-section of the receiving portion. The receiving portion enables the electrochemically active electrodes to be arranged in stacks between the pairs of parallel opposing lateral surfaces, whereby dead spaces can be better utilized and thus a higher energy density can be achieved. The larger surface area for the same volume compared with a completely circular-cylindrical battery cell allows more efficient temperature control. Finally, in the transition area between the circular-cylindrical end portion and the receiving portion, there is a stop surface extending transversely to the lateral surfaces, which facilitates the mounting of the battery cell with respect to its longitudinal axis.

The battery cells can be packed particularly densely in a battery module if adjacent lateral surfaces of the receiving portion are normal to each other. Since battery modules normally have a substantially rectangular basic shape, the packing density of the battery cells in the battery module can be increased if the lateral surfaces of the battery cells adjacent to the side walls of the battery module can be arranged parallel to these side walls. In this way, dead spaces forming in the flow channel can be minimized and a flow channel with a substantially constant cross-section can be made possible.

The battery cell can be stored in a fluid-cooled battery module in a stable and fluid-tight manner, regardless of the spatial orientation, if two opposing circular-cylindrical end portions are connected to the receiving portion. This allows the battery cell to be enclosed by a seal at both end portions and thus to be mounted in a fluid-tight manner. This limits the degrees of freedom of movement of the battery cell in the battery module, and it can be avoided that vibrations occurring during operation propagate to the battery cells and lead to uneven stressing of the seals and resulting leakage. In addition, the reduced movement of the battery cell in the battery module can enable a more uniform flow of temperature-control fluid around the battery cells.

The energy density in the battery cell can be increased if an electrode stack is accommodated in the receiving portion. An electrode stack always comprises one or more layers of anodes, separators and cathodes. The geometry of the receiving body according to the invention allows a higher energy density than a circular-cylindrical receiving body, since the electrodes can be stacked densely, preferably parallel to each other, in the receiving body. Since the lateral surfaces of the receiving body extend parallel to each other in pairs, in a preferred embodiment the electrodes and other active materials can be arranged densely packed parallel to two of these lateral surfaces. Possible electrode arrangements for an electrode stack include a winding around an elongated core in the manner of a prismatic cell or, particularly preferably, a layering or folding in the manner of a pouch cell.

The tightness of a battery module can be further improved in the event of electrochemically induced deformations on the battery cell if the circular-cylindrical end portions are formed without electrode stacks. In addition, this allows the individual electrodes in the circular-cylindrical end portions to be interconnected with each other and/or with an electrical contact pole led to the outside. In this context, the stop extending transversely to the lateral surfaces in the transition region between the receiving portion and the circular-cylindrical end portions prevents the electrode stack from escaping in the event of a fault and thus reduces the formation of short circuits within a battery module.

In order for the battery cell to be easily electrically contacted despite being stored in a fluid-cooled battery module, it is proposed that a circular-cylindrical end portion forms at least one electrical battery cell pole. In this way, the electrically conductive battery cell pole can be easily spatially delimited from the fluid channel and the electrical power can be easily tapped from the outside. This facilitates in particular serial, or parallel connections of several battery cells of different battery modules. The electrically opposing battery cell pole can either be formed by the remaining battery cell casing or by the opposite circular-cylindrical end portion.

A plurality of battery cells can be packed even more easily tightly in a given volume if the lateral surfaces of the receiving portion have the same size. This allows very flexible assembly of individual battery cells to form a battery module, because the adjacent lateral surfaces of two adjacent battery cells have the same dimensions if they are aligned in a correspondingly parallel manner. In the case where adjacent lateral surfaces of the receiving portion are normal to one another, this results in an essentially square cross-section of the receiving portion, wherein the edges can be rounded, not least for manufacturing reasons.

In order to be able to specify a constant distance between the individual battery cells, particularly in a battery module, and thus to promote the formation of flow channels between adjacent battery cells with predefined dimensions, the lateral surfaces of the receiving portion can have at least one spacer. It is irrelevant whether the spacer is formed integrally with the lateral surfaces or is placed on the lateral surfaces. One or more spacers can be provided for each lateral surface. In a particularly preferred embodiment, each of the lateral surfaces of the receiving portion has at least one spacer. To further promote the formation of fluid flow channels, the spacers can extend in the longitudinal direction of the battery cells over a height of at least 50%, in particular over a height of at least 80%, and particularly preferably over the entire height of the receiving portion. To prevent direct heat transfer between two adjacent battery cells, the spacers can be designed to be thermally insulating or have thermal insulation.

When using the battery cell according to the invention in a battery module, it is advisable for the lateral surfaces of the circular-cylindrical end portions to form sealing surfaces for sealing a flow channel for a temperature-control fluid.

The present invention also relates to a battery module having a plurality of battery cells according to the invention arranged parallel to one another. In the region of the receiving portions, this battery module comprises, in a preferred embodiment, a flow channel for a temperature-control fluid, wherein it is fundamentally irrelevant whether the receiving portions of the battery cells are arranged in a common flow channel for the temperature-control fluid, or whether merely adjacent lateral surfaces of the receiving portions delimit a temperature-control channel as a flow channel. The temperature-control channels can also be bounded by the spacers of the lateral surfaces.

In a particularly preferred embodiment, the receiving portions of the battery cells are arranged in a common flow channel and adjacent lateral surfaces of adjacent battery cells delimit a temperature-control channel for the temperature-control fluid.

In this case in particular, it is recommended that a collecting channel extending transversely to a longitudinal direction of the battery cells is provided for the temperature-control fluid, from which temperature-control channels extending in the longitudinal direction of the battery cells branch off. As a result of these measures, there can be a low pressure loss in the collecting channel, which preferably extends in the transition regions between the circular-cylindrical end portions and the receiving portions, and thus an even distribution of the temperature-control fluid, while the temperature-control channels following in the direction of flow have a higher pressure loss, so that the temperature-control fluid is distributed evenly over all the temperature-control channels. It is understood that a collecting channel for supplying and discharging the temperature-control fluid can also be provided on each side of the receiving portions.

Particularly favorable flow conditions arise in this context when the proportion of the total pressure drop within the flow channel accounted for by the temperature-control channels is 60-99%.

### BRIEF DESCRIPTION OF THE INVENTION

In the drawing, the subject matter of the invention is shown by way of example, wherein:

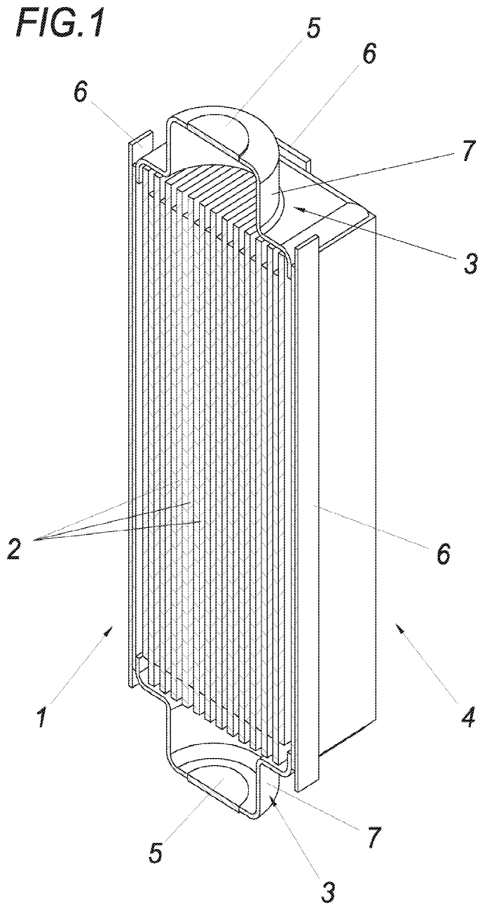

FIG. 1 shows a perspective view of a partially intersected battery cell according to the invention,

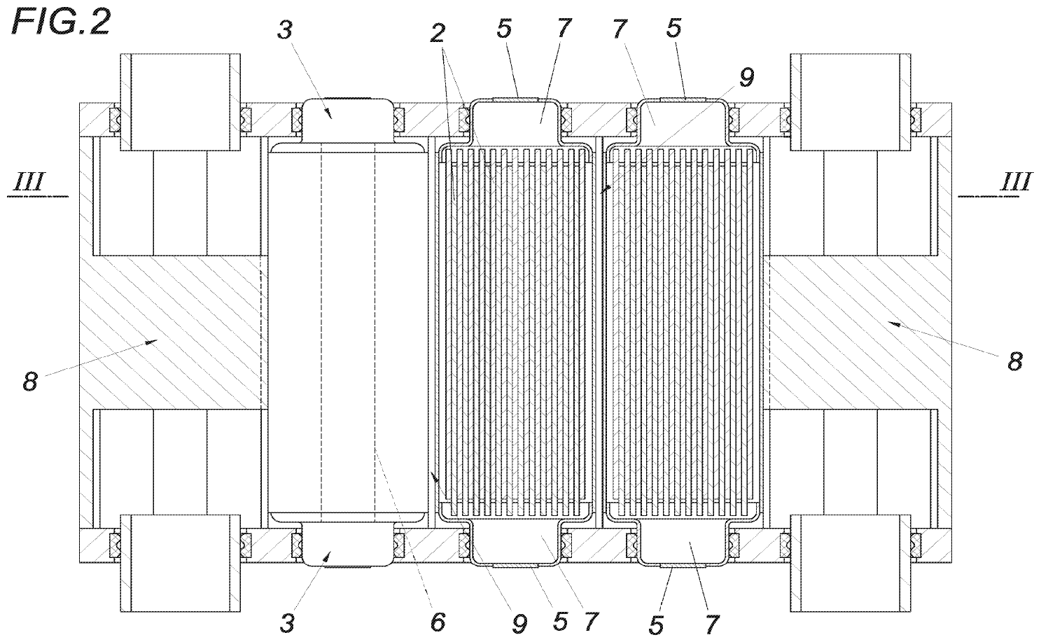

FIG. 2 shows a battery module having a plurality of battery cells according to the invention in a schematic cross-section and

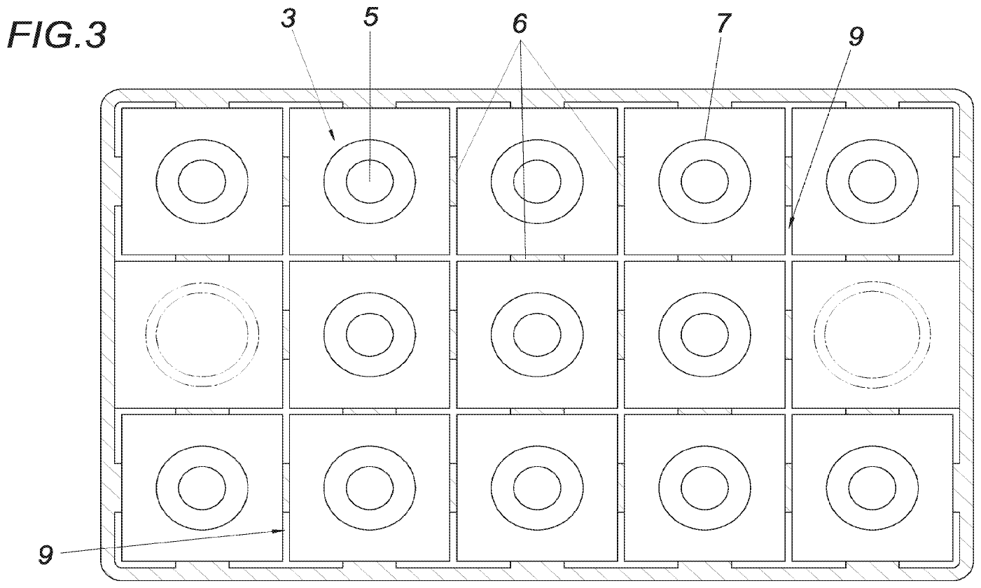

FIG. 3 shows a section along line III-III of FIG. 2.

### DETAILED DESCRIPTION OF THE PREFERRED EMBODIMENTS

A battery cell according to the invention comprises a cell casing 1 enclosing electrodes 2. The cell casing 1 comprises at least one circular-cylindrical end portion 3 and a receiving portion 4 with opposing parallel lateral surfaces in pairs. Particularly preferred operating conditions for storing the battery cells in a battery module are obtained if the battery cells have two opposing circular-cylindrical end portions 3 which adjoin the receiving portion 4. The battery cells can be sealed at the circular-cylindrical end portions 3 when the battery cell is stored in a battery module, so as to store the battery cell in the battery module in a fluid-tight manner. This enables reliable storage of the battery cells in a battery module, since undesirable rotations caused by vibrations can be better sealed against. Furthermore, when the battery cell is arranged in a battery module, power tapping is simplified when at least one circular-cylindrical end portion 3 forms an electrical battery cell pole 5. The connection between the electrodes 2 and the battery cell pole 5 is not shown for clarity.

As can be seen from FIG. 2 and FIG. 3, it is easier to pack the battery cells tightly if adjacent lateral surfaces of the receiving portion 4 are normal to each other. This allows greater flexibility in the arrangement of battery cells in a battery module with a given geometry. The electrodes 2 can be arranged within the receiving portion 4 in the manner of a pouch cell as a stack of electrodes, as shown in particular in FIGS. 1 and 2. In order to minimize cell breathing in the region of the circular-cylindrical end portions 3, the circular-cylindrical end portions 3 can be designed without electrode stacks. This minimizes deformation in the region of the circular-cylindrical end portions 3, and resulting leakage due to uneven sealing.

Particularly favorable temperature-control conditions are also obtained if the lateral surfaces of the receiving portion 4 have the same size, as the battery cells can thus be uniformly temperature-controlled over the lateral surfaces. If the lateral surfaces of the receiving portion 4 have spacers 6, this favors uniform temperature control of the battery cells in a battery module, since direct heat exchange between adjacent battery cells is reduced. For better fluid-tight mounting of the battery cells in a battery module, the circular-cylindrical end portions 3 can form sealing surfaces 7 that serve to seal a flow channel. The flow channel can have a collecting channel 8 and several temperature-control channels 9 extending between the battery cells and branching off from the collecting channel 8, whose share of the total pressure loss within the flow channel can be 60-99%. In a particularly preferred embodiment, the spacers 5 favor the formation of temperature-control channels 9 with the same cross-section.

1. A battery comprising:
electrodes surrounded by a cell casing;
wherein the cell casing has an end portion that is circular-cylindrical and forms a circular cylinder;
wherein the circular-cylindrical end portion is adjoined by a receiving portion having lateral surfaces that are supported in pairs in which the lateral surfaces are parallel opposite one anothers.

2. The battery cell according to claim 1, wherein lateral surfaces of the receiving portion that are mutually adjacent one another are normal to one another.

3. The battery cell according to claim 1, wherein a second circular-cylindrical end portion opposing the circular-cylindrical end portion the receiving portion.

4. The battery Bfittery cell according to claim 1, wherein an electrode stack is accommodated in the receiving portion.

5. The battery cell according to claim 4, wherein the circular-cylindrical end portion is formed without electrode stacks.

6. The battery cell according to claim 1, wherein the circular-cylindrical end portionforms at least one electrical battery cell pole.

7. The battery cell according to claim 1, wherein the lateral surfaces of the receiving portion have the same size.

8. The battery cell according to claim 1, wherein the lateral surfaces of the receiving portion have at least one spacer.

9. The battery cell according to claim 1, wherein the lateral surfaces of the circular-cylindrical end portions form sealing surfaces sealing a flow channel carrying therein a temperature-control fluid.

10. A battery module having comprising:
a plurality of battery cells according to claim 1 arranged parallel to one another;
wherein the receiving portions of the battery cells are arranged in a common flow channel carrying a temperature-control fluid.

11. A battery module comprising:
a plurality of battery cells according to claim 10, arranged parallel to one another;
wherein, in the receiving portions of the battery cells adjacent each other, the lateral surfaces that mutual adjoin each other delimit a temperature-control channel carrying a temperature-control fluid.

12. The battery module according to claim 10, wherein a collecting channel extending transversely to a longitudinal direction of the battery cells receives the temperature-control fluid, and temperature-control channels extending in the longitudinal direction of the battery cells branch off from the collecting channel.

13. The battery module according to claim 12, wherein the temperature-control channels have a share in a total pressure loss within the flow channel that is 60-99% thereof.

14. The battery module according to claim 11, wherein a collecting channel extending transversely to a longitudinal direction of the battery cells receives the temperature-control fluid, and temperature-control channels extending in the longitudinal direction of the battery cells branch off from the collecting channel.

15. The battery module according to claim 14, wherein the temperature-control channels have a share in a total pressure loss within the flow channel that is 60-99% thereof.

16. The battery cell according to claim 2, wherein a second circular-cylindrical end portion opposing the circular-cylindrical end portion adjoins the receiving portion.

17. The battery cell according to claim 16, wherein an electrode stack is accommodated in the receiving portion.

18. The battery cell according to claim 17, wherein the circular-cylindrical end portion is formed without electrode stacks.

19. The battery cell according to claim 16, wherein one of the circular-cylindrical end portions forms at least one electrical battery cell pole.

20. The battery cell according to claim 19, wherein the lateral surfaces of the circular-cylindrical end portions form sealing surfaces sealing a flow channel carrying therein a temperature-control fluid.
